(19) United States
(12) Patent Application Publication
(10) Pub. No.: US 2019/0129464 A1
(43) Pub. Date: May 2, 2019

(54) I3C CLOCK GENERATOR

(71) Applicant: QUALCOMM Incorporated, San Diego, CA (US)

(72) Inventors: Sharon GRAIF, Zichron Yakov (IL); Oren NISHRY, Bet Lham HaGlilit (IL); Shay MASWARI, Hadera (IL)

(21) Appl. No.: 16/162,564

(22) Filed: Oct. 17, 2018

Related U.S. Application Data
(60) Provisional application No. 62/579,994, filed on Nov. 1, 2017.

(51) Int. Cl. G06F 1/08; G06F 13/42

(52) U.S. Cl. CPC G06F 1/08; G06F 9/4498; G06F 13/4291

(57) ABSTRACT

System, methods and apparatus are described that enable the reliable generation of pulses in a clock signal transmitted over an I3C bus. In various aspects of the disclosure, a method of data communications may be performed by a master device to generate a clock signal to be transmitted on a serial bus. The method includes calculating a divisor based on frequency of a first clock signal and duration of a first pulse to be transmitted in a second clock signal over a clock line of the serial bus, using the divisor to divide the first clock signal to obtain a divided clock signal, and generating the first pulse using the divided clock signal.

### PRIORITY CLAIM

This application claims priority to and the benefit of U.S. Provisional Patent Application Ser. No. 62/579,994 filed in the U.S. Patent Office on Nov. 1, 2017, the entire content of this application being incorporated herein by reference as if fully set forth below in its entirety and for all applicable purposes.

### TECHNICAL FIELD

The present disclosure relates generally to an interface between processors and a peripheral devices and, more particularly, to improving data communications capabilities of a serial bus.

### BACKGROUND

Mobile communication devices may include a variety of components including circuit boards, integrated circuit (IC) devices and/or System-on-Chip (SoC) devices. The components may include processing circuits, user interface components, storage and other peripheral components that communicate through a serial bus. The serial bus may be operated in accordance with a standardized or proprietary protocol.

For example, the Inter-Integrated Circuit serial bus, which may also be referred to as the I2C bus or the I²C bus, is a serial single-ended computer bus that was intended for use in connecting low-speed peripherals to a processor. The I2C bus is a multi-master bus in which each device can serve as a master and a slave for different messages transmitted on the I2C bus. The I2C bus can transmit data using only two bidirectional open-drain connectors, including a Serial Data Line (SDA) and a Serial Clock Line (SCL). The connectors typically include signal wires that are terminated by pull-up resistors. Original implementations of I2C supported data signaling rates of up to 100 kilobits per second (100 kbps) in standard-mode (Sm) operation, with more recent standards supporting speeds of 400 kbps in fast-mode (Fm) operation, and 1 megabit per second (Mbps) in fast-mode plus (Fm+) operation.

The Mobile Industry Processor Interface (MIPI) Alliance has defined standards and protocols that may be used to operate a serial bus at higher data rates than permitted when the serial bus is operated in accordance with I3C protocols. In certain modes, I3C protocols inherit certain implementation aspects from I2C protocols. In one I3C mode, devices coupled to the bus may communicate in a single data rate (SDR) mode of operation, which may be compatible with I2C protocols used by conventional slave devices coupled to the serial bus. High data rate (HDR) modes are also defined for the I3C protocols, including HDR modes where SCL is clocked 12.5 Mhz.

Conventional slave devices that are limited to communicating through I2C protocols can coexist on the serial bus if they ignore HDR transmissions. In one HDR mode, data is transmitted over SDA in accordance with timing provided by a clock with shortened pulse widths (<50 ns) that is transmitted over SCL. In the latter mode, an I2C device can coexist on the bus with I3C devices if it includes a filter that blocks pulses of duration 50 ns or less.

In some systems and apparatus, higher bandwidths are required to support communications between certain types of devices. For example, mobile communications devices such as cellular phones may employ multiple devices, including cameras, displays and various communications interfaces that consume significant bandwidth. Higher bandwidths may be difficult to obtain when mixed signaling, including signaling according to conventional I2C protocols, is to be used in order to maintain compatibility with legacy devices. Accordingly, there exists an ongoing need for providing optimized communications on serial interfaces configured as a bus connecting master and slave components within a mobile device.

### SUMMARY

Embodiments disclosed herein provide systems, methods and apparatus that may be employed to generate clock signals for transmission over a serial bus. The clock signals may include a sequence of clock pulses that have a duration of less than 50 nanoseconds (50 ns).

In various aspects of the disclosure, a method of data communications may be performed by a master device to generate a clock signal to be transmitted on a serial bus. The method includes calculating a divisor based on frequency of a first clock signal and a maximum pulse duration configured for clock pulses in a second clock signal, where the second clock signal is transmitted over a clock line of a serial bus, using the divisor to select a first number of cycles of the first clock signal corresponding to a first pulse width that has a duration less than the maximum pulse duration, and providing a first clock pulse in the second clock signal having the first pulse width.

In certain aspects, the method includes using the divisor to select a second number of cycles of the first clock signal that selects a clock period for the second clock signal, and providing a second clock pulse in the second clock signal after the first clock pulse is terminated and after a delay defined by the second number of cycles of the first clock signal. The method may include providing a third clock pulse in the second clock signal after the second clock pulse is terminated and after a delay defined by the second number of cycles of the first clock signal and one or more additional cycles of the first clock signal. The method may include providing a first control pulse in one or more control signals. The first clock pulse may be initiated in the second clock signal responsive to the first control pulse. The method may include providing a second control pulse in the one or more control signals after the first control pulse. The second clock pulse may be initiated in the second clock signal responsive to the second control pulse. The method may include providing a terminating control pulse in the one or more control signals after the first control pulse. The first clock pulse may be terminated responsive to the terminating control pulse.

In certain aspects, the method includes determining that the first clock signal has a changed frequency, recalculating the divisor based on the changed frequency and the maximum pulse duration configured for clock pulses in the second clock signal, using the recalculated divisor to select an updated number of cycles of the first clock signal corresponding to a second pulse width that has a duration less than the maximum pulse duration, and providing at least one clock pulse in the second clock signal having the second pulse width. The frequency of the first clock signal may change in response to a power-management command.

In some aspects, the maximum pulse duration is selected to cause a spike filter of an I2C slave device to suppress the first clock pulse. The duration of the maximum pulse duration may be less than 50 nanoseconds. The second clock signal may be generated when the serial bus is operated in an I3C high data rate mode of operation.

In various aspects of the disclosure, a data communication apparatus has an interface circuit adapted to couple the apparatus to a serial bus, a processing system and a clock divider circuit. The processing system may be configured to calculate a divisor based on frequency of a first clock signal and a maximum pulse duration configured for clock pulses in a second clock signal. The second clock signal may be transmitted over a clock line of a serial bus. The clock divider circuit may be configured to use the divisor to select a first number of cycles of the first clock signal corresponding to a first pulse width that has a duration less than the maximum pulse duration, and provide a first clock pulse in the second clock signal having the first pulse width

In various aspects of the disclosure, a processor-readable storage medium stores code for calculating a divisor based on frequency of a first clock signal and a maximum pulse duration configured for clock pulses in a second clock signal, where the second clock signal is transmitted over a clock line of a serial bus, using the divisor to select a first number of cycles of the first clock signal corresponding to a first pulse width that has a duration less than the maximum pulse duration, and providing a first clock pulse in the second clock signal having the first pulse width.

In various aspects of the disclosure, a data communication apparatus includes means for calculating a divisor based on frequency of a first clock signal and a maximum pulse duration configured for clock pulses in a second clock signal, where the second clock signal is transmitted over a clock line of a serial bus, means for generating clock pulses configured to use the divisor to select a first number of cycles of the first clock signal corresponding to pulse width of the clock pulses, the pulse width having a duration less than the maximum pulse duration, and means for transmitting the clock pulses in the second clock signal.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates a configuration of I2C and I3C slave devices connected to a common serial bus.

FIG. 4 illustrates certain aspects of the timing relationship between SDA and SCL wires on a conventional I2C bus.

FIG. 5 is a timing diagram that illustrates timing associated with multiple frames transmitted on an I2C bus.

FIG. 6 illustrates timing related to a command word sent to a slave device in accordance with I2C protocols.

FIG. 7 illustrates the timing of pulses that may be filtered by I2C devices.

FIG. 8 illustrates an example of I3C HDR clock timing that may be ignored by I2C devices according to certain aspects disclosed herein.

FIG. 9 illustrates modes of controlling generation of pulses in a clock signal transmitted on SCL in accordance with certain aspects disclosed herein.

FIG. 10 illustrates timing associated with the generation of SCL clock signals for different base clocks in accordance with certain aspects disclosed herein.

FIG. 11 illustrates a clock generation circuit operable in accordance with certain aspects disclosed herein.

FIG. 12 is a flowchart that illustrates an example of a process used to configure a master device for I3C HDR mode communication over a serial bus in accordance with certain aspects disclosed herein.

FIG. 13 illustrates an example of a hardware implementation for a receiving apparatus that communicates over an I2C/I3C bus according to one or more aspects disclosed herein.

FIG. 14 is a flow chart of a method for detecting capabilities of devices coupled to a serial bus according to one or more aspects disclosed herein.

FIG. 15 illustrates an example of a hardware implementation for an apparatus employing a processing employing a processing circuit adapted according to certain aspects disclosed herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Certain aspects of the invention may be applicable to communications links deployed between electronic devices that are subcomponents of a mobile apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similarly functioning device.

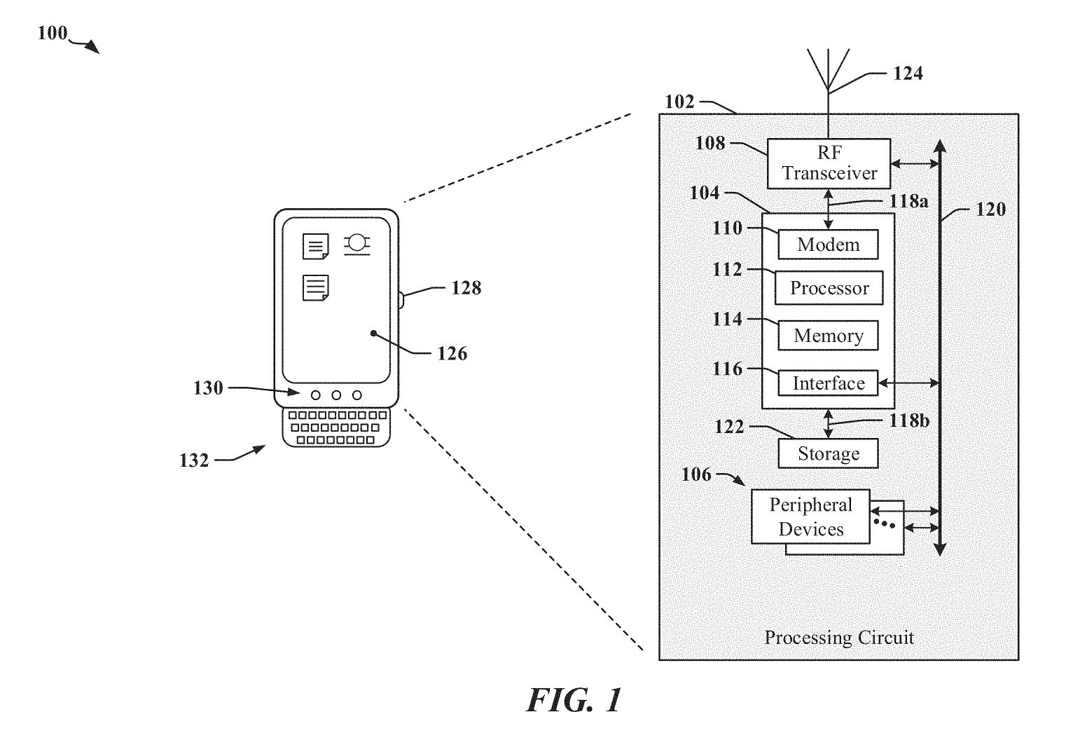

FIG. 1 illustrates an example of an apparatus 100 that may employ a data communication bus. The apparatus 100 may include a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

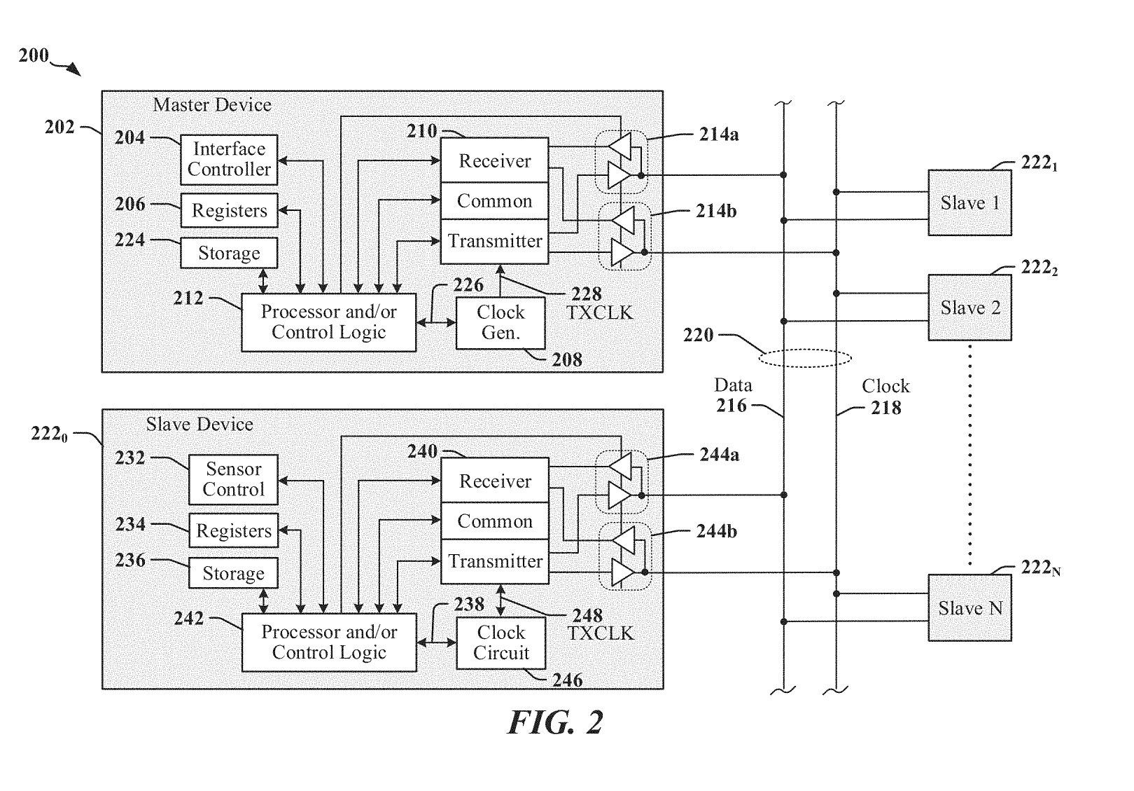

FIG. 2 illustrates certain aspects of an apparatus 200 that includes multiple devices 202, and 222₀-222_{N} coupled to a serial bus 220. The devices 202 and 222₀-222_{N} may be implemented in one or more semiconductor IC devices, such as an application processor, SoC or ASIC. In various implementations the devices 202 and 222₀-222_{N} may include, support or operate as a modem, a signal processing device, a display driver, a camera, a user interface, a sensor, a sensor controller, a media player, a transceiver, and/or other such components or devices. In some examples, one or more of the slave devices 222₀-222_{N} may be used to control, manage or monitor a sensor device. Communication between devices 202 and 222₀-222_{N} over the serial bus 220 is controlled by a bus master 202. Certain types of bus can support multiple bus master devices 202.

In one example, a bus master device 202 may include an interface controller 204 that may manage access to the serial bus, configure dynamic addresses for slave devices 222₀-222_{N} and/or generate a clock signal 228 to be transmitted on a clock line 218 of the serial bus 220. The bus master device 202 may include configuration registers 206 or other storage 224, and other control logic 212 configured to handle protocols and/or higher level functions. The control logic 212 may include a processing circuit having a processing device such as a state machine, sequencer, signal processor or general-purpose processor. The bus master device 202 includes a transceiver 210 and line drivers/receivers 214a and 214b. The transceiver 210 may include receiver, transmitter and common circuits, where the common circuits may include timing, logic and storage circuits and/or devices. In one example, the transmitter encodes and transmits data based on timing in the clock signal 228 provided by a clock generation circuit 208. Other timing clocks 226 may be used by the control logic 212 and other functions, circuits or modules.

At least one device 222₀-222_{N} may be configured to operate as a slave device on the serial bus 220 and may include circuits and modules that support a display, an image sensor, and/or circuits and modules that control and communicate with one or more sensors that measure environmental conditions. In one example, a slave device 222₀ configured to operate as a slave device may provide a control function, module or circuit 232 that includes circuits and modules to support a display, an image sensor, and/or circuits and modules that control and communicate with one or more sensors that measure environmental conditions. The slave device 222₀ may include configuration registers 234 or other storage 236, control logic 242, a transceiver 240 and line drivers/receivers 244a and 244b. The control logic 242 may include a processing circuit having a processing device such as a state machine, sequencer, signal processor or general-purpose processor. The transceiver 210 may include receiver, transmitter and common circuits, where the common circuits may include timing, logic and storage circuits and/or devices. In one example, the transmitter encodes and transmits data based on timing in a clock signal 248 provided by clock generation and/or recovery circuits 246. The clock signal 228 may be derived from a signal received from the clock line 218. Other timing clocks 238 may be used by the control logic 242 and other functions, circuits or modules.

The serial bus 220 may be operated in accordance with RFFE, I2C, I3C, SPMI, or another protocol. At least one device 202, 222₀-222_{N} may be configured to operate as a bus master device on the serial bus 220. Two or more devices 202, 222₀-222_{N} may be configured to operate as a bus master device on the serial bus 220.

In some implementations, the serial bus 220 may be operated in accordance with an I3C protocol. Devices that communicate using the I3C protocol can coexist on the same serial bus 220 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may be provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 220, in addition to data formats and aspects of bus control. In some aspects, the I2C and I3C protocols may define direct current (DC) characteristics affecting certain signal levels associated with the serial bus 220, and/or alternating current (AC) characteristics affecting certain timing aspects of signals transmitted on the serial bus 220. In some examples, a 2-wire serial bus 220 transmits data on a data line 216 and a clock signal on the clock line 218. In some instances, data may be encoded in the signaling state, or transitions in signaling state of the data line 216 and the clock line 218.

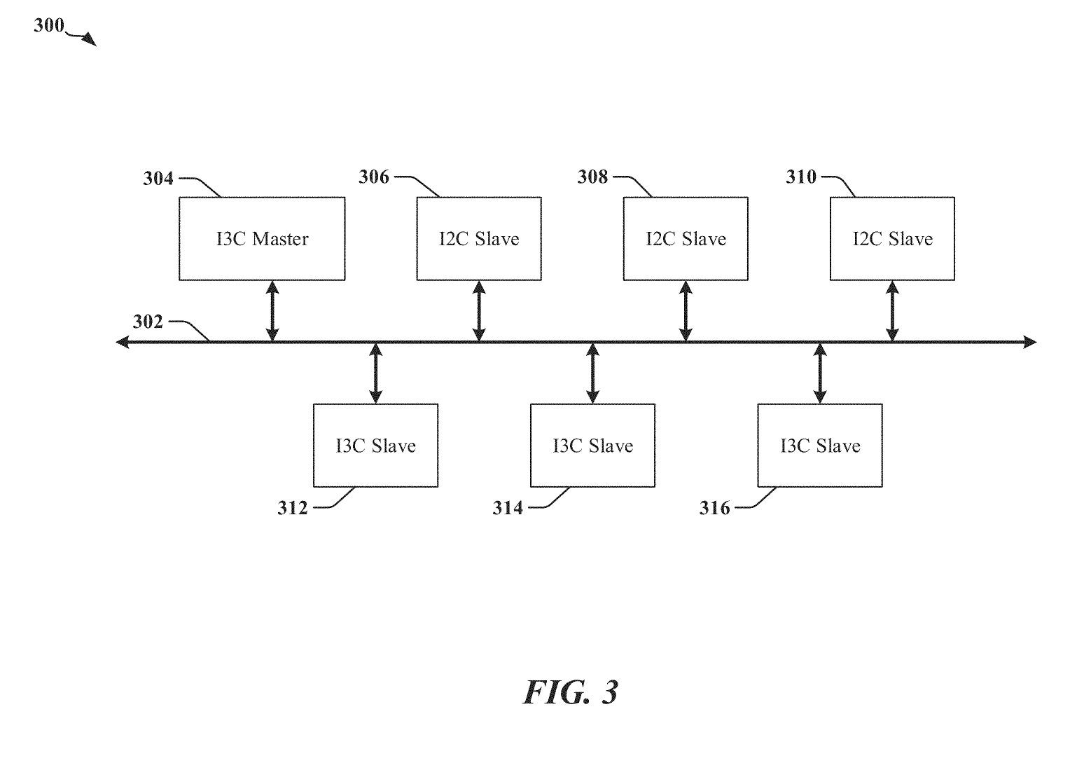

FIG. 3 illustrates certain aspects of an apparatus 300 in which a variety of devices 304, 306, 308, 310, 312, 314 and 316 are coupled to a serial bus 302, and in which I3C devices 304, 312, 314 and 316 may be adapted or configured to obtain higher data transfer rates over the serial bus 302 using I3C protocols. The I3C devices 304, 312, 314 and 316 may coexist with conventionally configured I2C devices 306, 308 and 310. The I3C devices 304, 312, 314 and 316 may alternatively or additionally communicate using conventional I2C protocols, as desired or needed.

The serial bus 302 may be operated at higher data transfer rates when an enhanced master device 304 controls the serial bus 302 in accordance with an I3C protocol. In the depicted example, a single master device 304 may serve as a bus master in I2C mode and in an I3C mode that supports a data transfer rate that exceeds the data transfer rate achieved when the serial bus 302 is operated according to a conventional I2C protocol. The signaling used for higher data-rate traffic may take advantage of certain features of I2C protocols such that the higher data-rate traffic can be carried over the serial bus 302 without compromising the functionality of legacy I2C devices 306, 308 and 310 coupled to the serial bus 302.

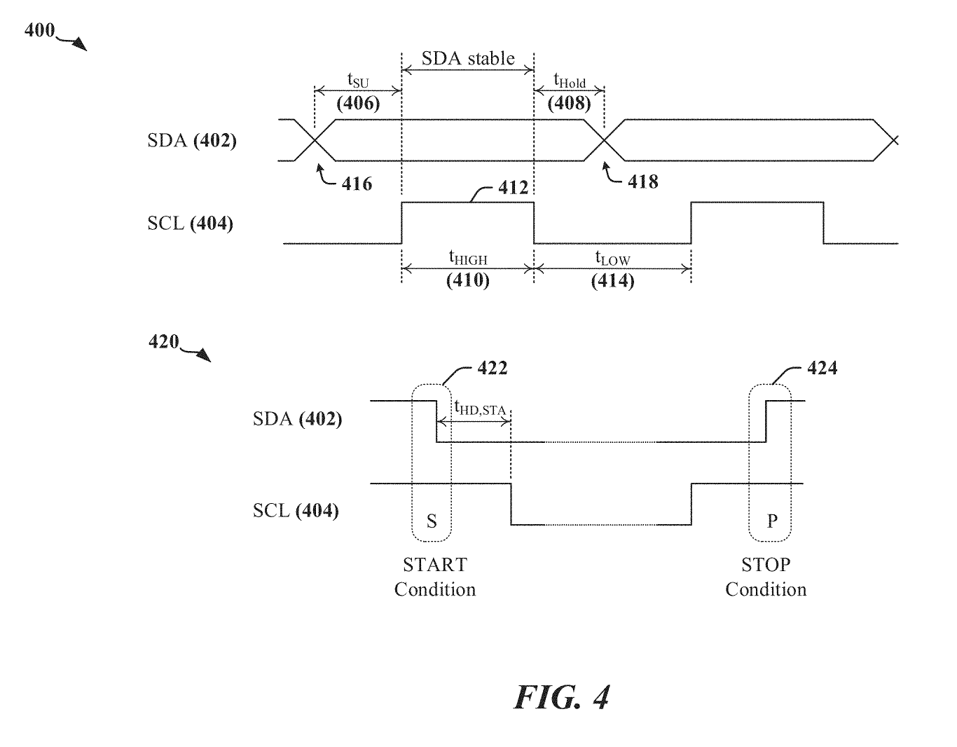

Certain signaling defined in I3C specifications is derived from, or otherwise based on I2C protocols. FIG. 4 includes timing diagrams 400 and 420 that illustrate the relationship between signals transmitted over the SDA wire 402 and the SCL wire 404 of a conventional I2C bus. The first timing diagram 400 illustrates the timing relationship between signals transmitted using the SDA wire 402 and the SCL wire 404 while data is being transferred on the conventionally configured I2C bus. The SCL wire 404 provides a series of pulses that can be used to sample data in the SDA wire 402. The pulses (including the pulse 412, for example) may be defined as the time during which the SCL wire 404 is determined to be in a high logic state at a receiver. When the SCL wire 404 is in the high logic state during data transmission, data on the SDA wire 402 is required to be stable and valid; the state of the SDA wire 402 is not permitted to change when the SCL wire 404 is in the high logic state.

Specifications for conventional I2C protocol implementations (which may be referred to as “I2C Specifications”) define a minimum duration 410 (t_{HIGH}) of the high period of the pulse 412 on the SCL wire 404. The I2C Specifications also define minimum durations for a setup time 406 (t_{SU}) before occurrence of the pulse 412, and a hold time 408 (t_{Hold}) after the pulse 412 terminates. The signaling state of the SDA wire 402 is expected to be stable during the setup time 406 and the hold time 408. The setup time 406 defines a maximum time period after a transition 416 between signaling states on the SDA wire 402 until the arrival of the rising edge of the pulse 412 on the SCL wire 404. The hold time 408 defines a minimum time period after the falling edge of the pulse 412 on the SCL wire 404 until a next transition 418 between signaling states on the SDA wire 402. The I2C Specifications also define a minimum duration 414 for a low period (t_{LOW}) for the SCL wire 404. The data on the SDA wire 402 is typically stable and/or can be captured for the duration 410 (t_{HIGH}) when the SCL wire 404 is in the high logic state after the leading edge of the pulse 412.

The second timing diagram 420 of FIG. 4 illustrates signaling states on the SDA wire 402 and the SCL wire 404 between data transmissions on a conventional I2C bus. The I2C protocol provides for transmission of 8-bit data (bytes) and 7-bit addresses. A receiver may acknowledge transmissions by driving the SDA wire 402 to the low logic state for one clock period. The low signaling state represents an acknowledgement (ACK) indicating successful reception and a high signaling state represents a negative acknowledgement (NACK) indicating a failure to receive or an error in reception.

A START condition 422 is defined to permit the current bus master to signal that data is to be transmitted. The START condition 422 occurs when the SDA wire 402 transitions from high to low while the SCL wire 404 is high. The I2C bus master initially transmits the START condition 422, which may be also be referred to as a start bit, followed by a 7-bit address of an I2C slave device with which it wishes to exchange data. The address is followed by a single bit that indicates whether a read or write operation is to occur. The addressed I2C slave device, if available, responds with an ACK bit. If no I2C slave device responds, the I2C bus master may interpret the high logic state of the SDA wire 402 as a NACK. The master and slave devices may then exchange bytes of information in frames, in which the bytes are serialized such that the most significant bit (MSB) is transmitted first. The transmission of the byte is completed when a STOP condition 424 is transmitted by the I2C master device. The STOP condition 424 occurs when the SDA wire 402 transitions from low to high while the SCL wire 404 is high. The I2C Specifications require that all transitions of the SDA wire 402 occur when the SCL wire 404 is low, and exceptions may be treated as a START condition 422 or a STOP condition 424.

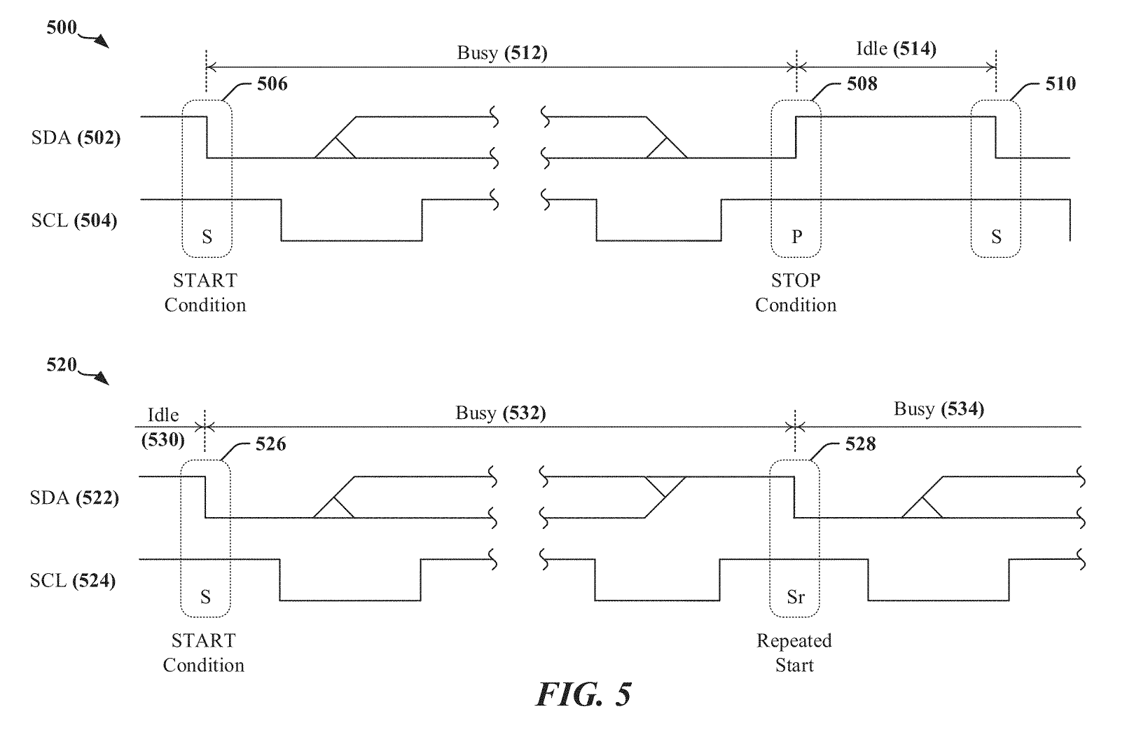

FIG. 5 includes diagrams 500 and 520 that illustrate timing associated with data transmissions using the SDA wire 502 and SCL wire 504 of an I2C bus. As illustrated in the first diagram 500, an idle period 514 may occur between a STOP condition 508 and a START condition 510 that follows the STOP condition 508. This idle period 514 may be prolonged, and may result in reduced data throughput when the conventional I2C bus remains idle between the STOP condition 508 and the consecutive START condition 510. In operation, a busy period 512 commences when the I2C bus master transmits a first START condition 506, followed by data. The busy period 512 ends when the I2C bus master transmits a STOP condition 508 and the idle period 514 ensues. The idle period 514 ends when a second START condition 510 is transmitted.

The second timing diagram 520 illustrates a method by which the number of occurrences of an idle period 514 may be reduced. In the illustrated example, data is available for transmission before a first busy period 532 ends. The I2C bus master device may transmit a Repeated Start 528 (Sr) rather than a STOP condition. The Repeated Start 528 terminates the preceding data transmission and simultaneously indicates the commencement of a next data transmission. The state transition on the SDA wire 522 corresponding to the Repeated Start 528 is identical to the state transition on the SDA wire 522 for a start condition 526 that occurs after an idle period 530. For both the start condition 526 and the Repeated Start 528, the SDA wire 522 transitions from high to low while the SCL wire 524 is high. When a Repeated Start 528 is used between data transmissions, a first busy period 532 is immediately followed by a second busy period 534.

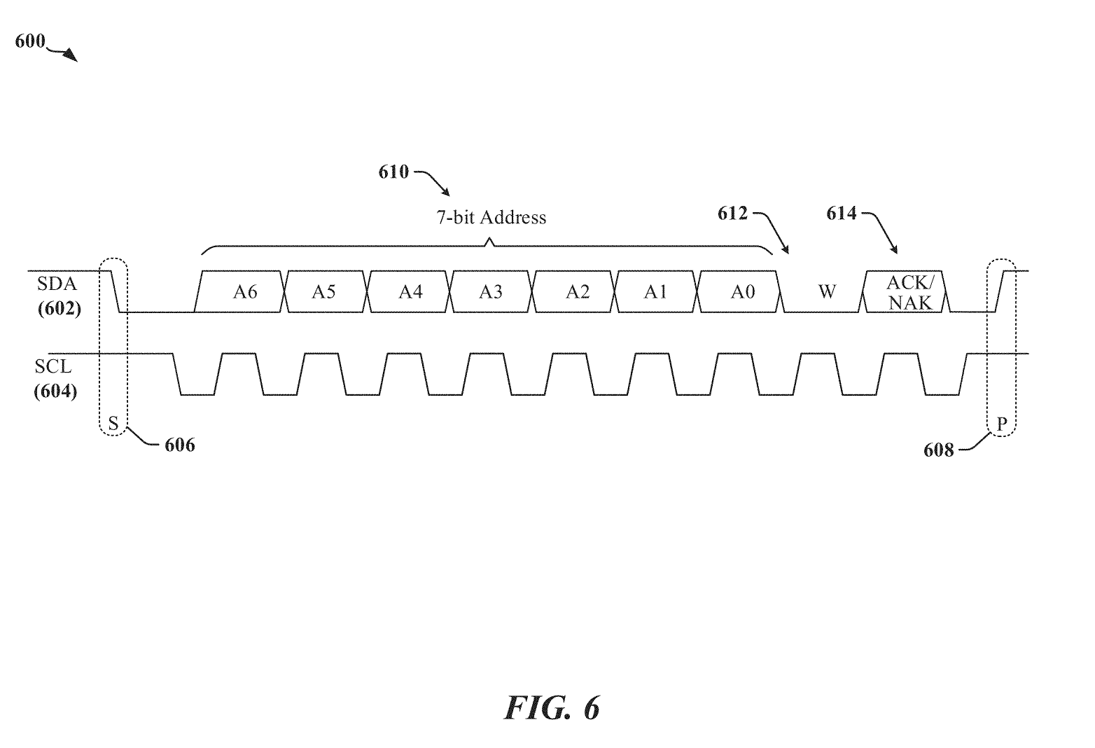

FIG. 6 is a diagram 600 that illustrates an example of the timing associated with a command word sent to a slave device in accordance with I2C protocols. In the example, a master device initiates the transaction with a start condition 606, whereby the SDA wire 602 is driven from high to low while the SCL wire remains high. The master device then transmits a clock signal on the SCL wire 604. The seven-bit address 610 of a slave device is then transmitted on the SDA wire 602. The seven-bit address 610 is followed by a Write/Read command bit 612, which indicates “Write” when low and “Read” when high. The slave device may respond in the next clock interval 614 with an acknowledgment (ACK) by driving the SDA wire 602 low. If the slave device does not respond, the SDA wire 602 is pulled high and the master device treats the lack of response as a NACK. In the illustrated example, the master device terminates the transaction with a stop condition 608 by driving the SDA wire 602 from low to high while the SCL wire 604 is high. This transaction can be used to determine whether a slave device with the transmitted address coupled to the I2C bus is in an active state.

With continued reference to FIG. 3, certain aspects relate to implementations in which provide higher data rates between I3C devices 304, 312, 314, 316 that are higher than data rates supported by I2C protocols. For example, the increased data rates for communication between I3C devices 304, 312, 314, 316 coupled to the serial bus 302 may be achieved by increasing clock rates on the serial bus 302. Legacy I2C devices 306, 308 and 310 may be unable to handle the increased clock frequencies and/or may misinterpret signaling transmitted between I3C devices 304, 312, 314, 316. According to certain aspects, increased data rates for communication between I3C devices 304, 312, 314, 316 may be achieved using shortened pulse widths on the clock signal. Pulses with shortened pulse widths may be ignored by legacy I2C devices 306, 308 and 310 due to the presence of spike filters in the receivers of the legacy I2C devices 306, 308 and 310.

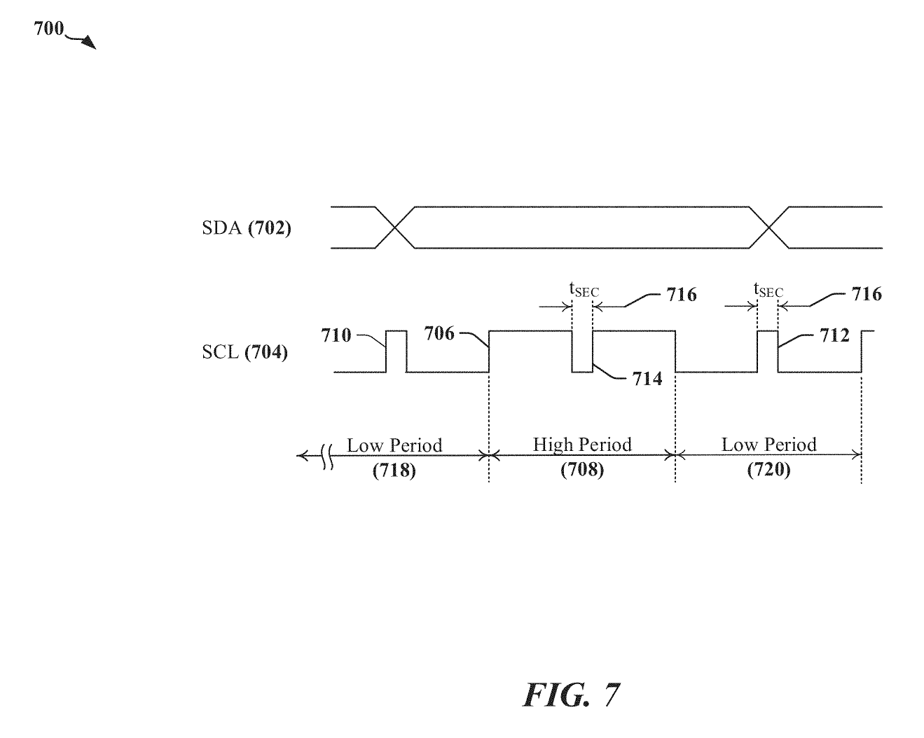

FIG. 7 is a timing diagram 700 that illustrates the timing of pulses that may be filtered by legacy I2C devices 306, 308 and 310. The SCL wire 704 may carry one or more pulses 706 that conform or comply with I2C protocols. That is, the pulses 706 have a high period 708 of a duration that exceeds the minimum duration specified for a pulse by the I2C protocol. The low period 718 preceding the pulse and the low period 720 following the pulse have durations that exceed the minimum low duration specified by the I2C protocol. In the timing diagram 700, short positive-transitioning spikes or pulses 710 and 712 may be filtered by a spike filter provided in the receiver of the legacy I2C devices 306, 308 and 310. The spike filter may also filter the short negative-transitioning spike or pulse 714.

The I2C Specifications define a pulse width for a spike (t_{SP}) that must be suppressed by an input filter of a conventional I2C receiver in certain modes of operation. In one example, t_{SP}=50 ns, and a pulse having a duration that is less than 50 ns is expected to be blocked by an I2C compliant spike filter. Applying this example to FIG. 7, any of the pulses 710, 712, 714 that are shorter than 50 ns are expected to be filtered and ignored by conventional I2C receivers. I3C devices 304, 312, 314, 316 may communicate without affecting I2C devices 306, 308 and 310 by transmitting pulses with a duration 716 (t_{SEC}) that is less than the t_{SP} pulse width on the SDA wire 702 and/or SCL wire 704, where t_{SP} is specified by the I2C Specifications.

### Short Pulses for I3C Transactions

Referring again to FIG. 3, MIPI Alliance standards and protocols for I3C provide HDR modes that can be employed for communicating between I3C devices 304, 312, 314 and 316 when I2C devices 306, 308 and 310 are coupled to a shared serial bus 302. In certain HDR modes, and I3C master device 304 may provide a clock signal on SCL where clock pulses have a duration that is shorter than 50 ns. According to protocol, I2C devices 306, 308 and 310 with a 50 ns spike filter can coexist on a serial bus 302 operated with I3C devices 304, 312, 314 and 316. The spike filter causes the I2C devices 306, 308 and 310 to ignore signaling on the serial bus 302.

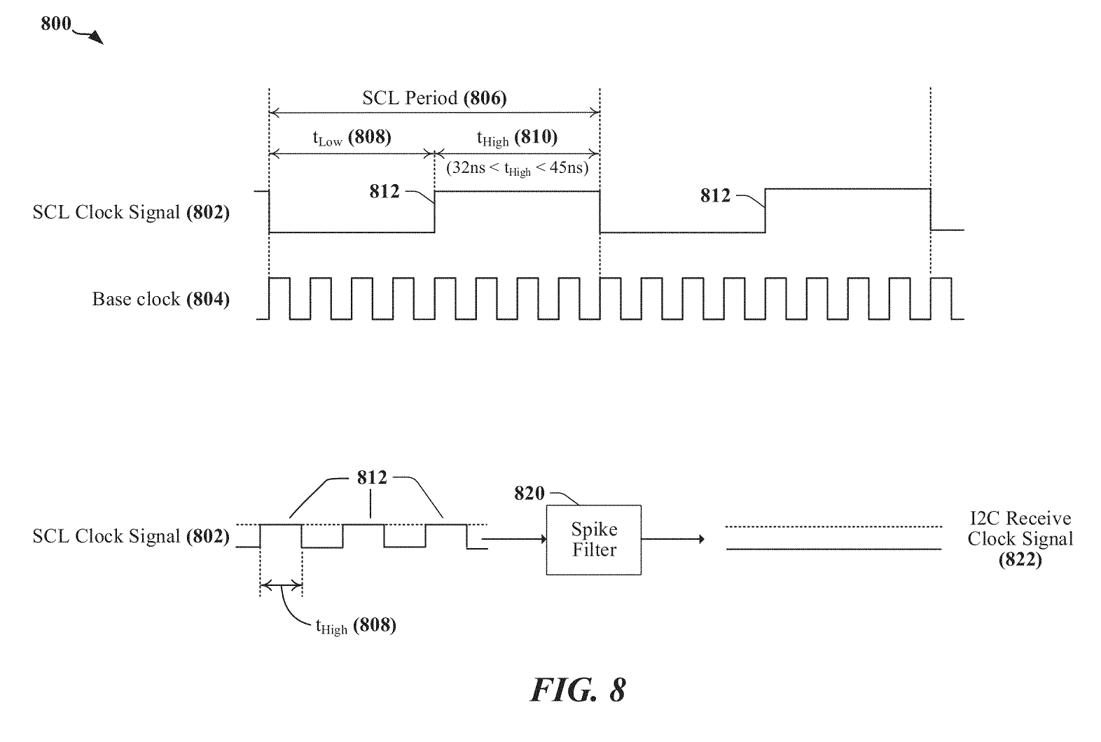

FIG. 8 is a diagram 800 that illustrates an example of I3C HDR clock timing that may be ignored by I2C devices 306, 308 and 310. Each of the I2C devices 306, 308 and 310 may be equipped with a spike filter 820 that suppresses pulses 812 with a duration that is less than 50 ns. In accordance with I3C protocols, a clock signal 802 transmitted in an HDR mode includes pulses 812 that are in a high state 810 for a duration (two) that lies in the range 32 ns<t_{HIGH}<45 ns. The spike filter 820 in each I2C device 306, 308 and 310 receives the clock signal 802 from the serial link and suppresses the pulses 812 to provide an internal receive clock signal 822 that is quiescent. The I2C devices 306, 308 and 310 do not recognize signaling on the serial bus when the receive clock signal 822 remains in the low voltage state. I3C devices 304, 312, 314 and 316 respond to the pulses 812 in the transmitted clock signal 802 and can exchange data over the serial bus in accordance with one or more I3C HDR protocols.

The clock signal 802 transmitted on SCL is generated by an I3C master device 304. In many instances, the I3C master device 304 generates the clock signal 802 using a base clock 804 that may be provided by an IC such as an application processor, in which the I3C master device 304 may be embodied, in a clock generator provided in the I3C master device 304, and/or from a power management system. In the example illustrated in FIG. 8, the clock signal 802 transmitted on SCL may be generated by dividing the base clock 804 by 4, using a counter or flip-flops, etc. The width of the pulses 812 is constrained by protocol within a relatively narrow 13 ns margin, and the circuits that generate and conduct the base clock 804 and the clock signal 802 transmitted on SCL may be designed to provide a high state 810 that lies within specified tolerances. In some instances, the master device 304 may stretch the period 806 of the clock signal 802 transmitted on SCL, which can be accomplished by extending the low state 808. When the clock signal 802 is stretched, the duration of the high state 810 is required by protocol to remain within specified limits. Stretching can be difficult to accomplish when the clock signal 802 transmitted on SCL is obtained by binary division of the base clock 804.

The frequency of the base clock 804 may be variable. For example, the master device 304 may be embodied in a device that is subject to power control, where the device may be required to reduce power consumption at certain times and may be permitted to increase power consumption on a limited basis to execute high-priority and/or time sensitive operations. The frequency of the base clock 804 may be decreased to conserve power, and may be increased to improve device performance. The specifications for frequency and pulse width of the clock signal 802 transmitted on SCL during a selected mode of operation is typically unaffected by changes in frequency of the base clock 804. When the clock frequency of the base clock 804 changes or the clock signal 802 for transmission on SCL is stretched, the circuits used to generate the clock signal 802 for transmission on SCL are necessarily reconfigured to maintain specified pulse widths during I3C HDR modes. Reconfigurable clock generation circuits may be complex and costly to implement in certain devices.

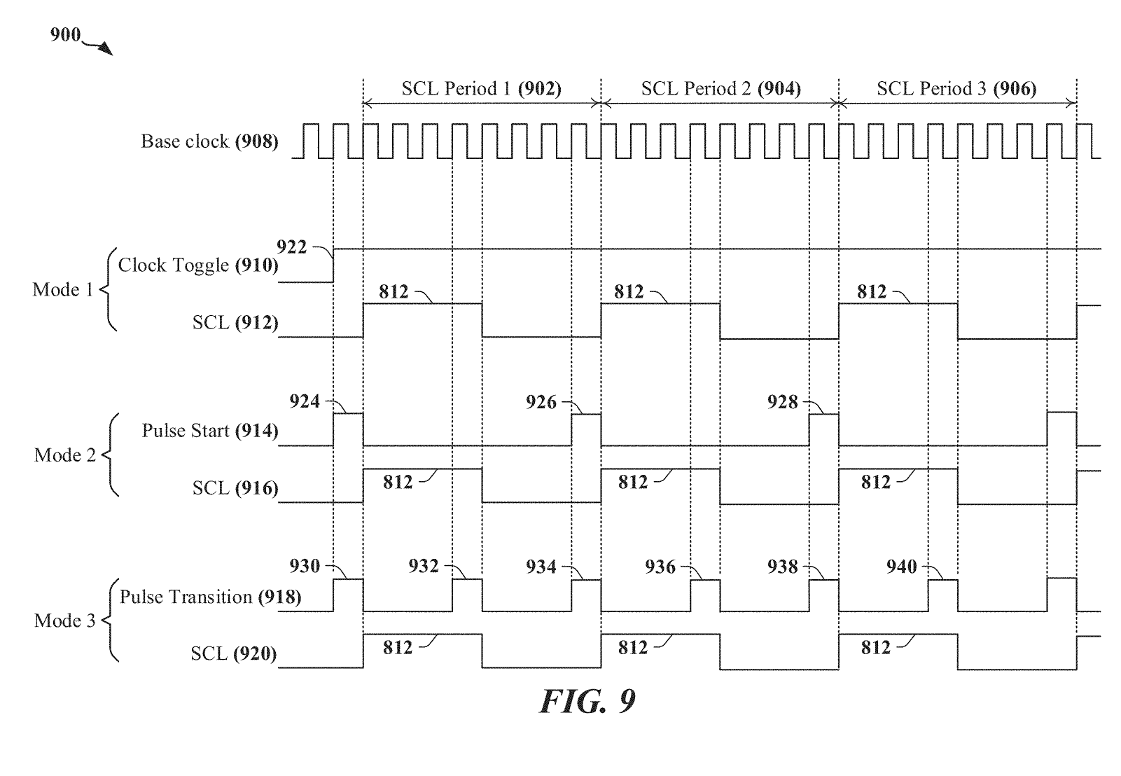

With reference to FIGS. 9-11, a clock generation circuit 1100 that can reliably configure pulse width of the clock signal transmitted on SCL is disclosed herein.

FIG. 9 is a diagram 900 that illustrates certain modes of controlling the generation of pulses in the clock signal transmitted on SCL using a base clock signal 908. In a first mode of operation, the clock generation circuit 1100 provides a clock toggle signal 910 to cause pulses 812 in the SCL signal 912 to be generated automatically. The duration of the pulses 812 in the SCL signal 912 are generated to meet protocol requirements, and each pulse 812 is automatically launched at the beginning of a corresponding SCL period 902, 904, 906. The duration of the pulses 812 may be defined as a fixed number of cycles of the base clock signal 908. In the illustrated example, the duration of the pulses 812 is four times the period of the base clock signal 908. The number of cycles may be selected based on the frequency of the base clock signal 908. In the first mode, the duration of the SCL period 902, 904, 906 may vary without affecting the duration of the pulses 812.

In a second mode of operation, the clock generation circuit 1100 provides a pulse start signal 914 to control and time the generation of pulses 812 in the SCL signal 916. The duration of the pulses 812 in the SCL signal 916 are generated to meet protocol requirements. Each pulse 812 is launched at the beginning of a corresponding SCL period 902, 904, 906, after a control pulse 924, 926, 928 has been generated on the pulse start signal 914. In the illustrated example, the control pulses 924, 926, 928 have a duration of one cycle of the base clock signal 908 and pulses 812 are initiated in the SCL signal 916 on the falling edge of the control pulses 924, 926, 928. The duration of the SCL period 902, 904, 906 is controlled by the timing of the control pulses 924, 926, 928 and may vary without affecting the duration of the pulses 812 in the SCL signal 916. The duration of the pulses 812 may be defined as a fixed number of cycles of the base clock signal 908. In the illustrated example, the duration of the pulses 812 is four times the period of the base clock signal 908. The number of cycles may be selected based on the frequency of the base clock signal 908.

In the first and second modes, a divider circuit in the clock generation circuit 1100 can be configured to control duration of the pulses 812 in the SCL signal 912, 916 based on the current frequency of the base clock signal 908. In the first mode, the duration of the low state between pulses 812 is typically fixed, and may be equal to the duration of the pulses 812. In the second mode, both the duration of the low state between pulses 812 and the duration of the pulses 812 may be controlled and/or controlled according to application needs. In one example, the duration of the low state between pulses 812 may be controlled by selecting the number of cycles of the base clock signal 908 that defines the duration of the control pulses 924, 926, 928.

In third mode of operation, the clock generation circuit 1100 provides a pulse transition signal 918 to control and time the generation of edges in the SCL signal 920. The duration of the pulses 812 in the SCL signal 920 is determined by the timing of pairs of control pulses 930/932, 934/936, 938/940 in the pulse transition signal 918. The timing of the control pulses 930, 932, 934, 936, 938, 940 is configured to select the duration of the SCL periods 902, 904, 906, and to define the duration of the pulses 812 in the SCL signal 920 in accordance with protocol requirements. Each pulse 812 is initiated at the beginning of a corresponding SCL period 902, 904, 906, after a first control pulse 930, 934, 938 has been provided in the pulse transition signal 918. Each pulse 812 is terminated at the end of a corresponding SCL period 902, 904, 906, after a second control pulse 932, 936, 940 has been provided in the pulse transition signal 918. In the illustrated example, the control pulses 930, 932, 934, 936, 938, 940 have a duration of one cycle of the base clock signal 908 and pulses 812 occur in the SCL signal 920 on the falling edge of the control pulses 930, 932, 934, 936, 938, 940. The duration of the SCL period 902, 904, 906 and the duration of the pulses 812 in the SCL signal 920 may be independently determined in the third mode.

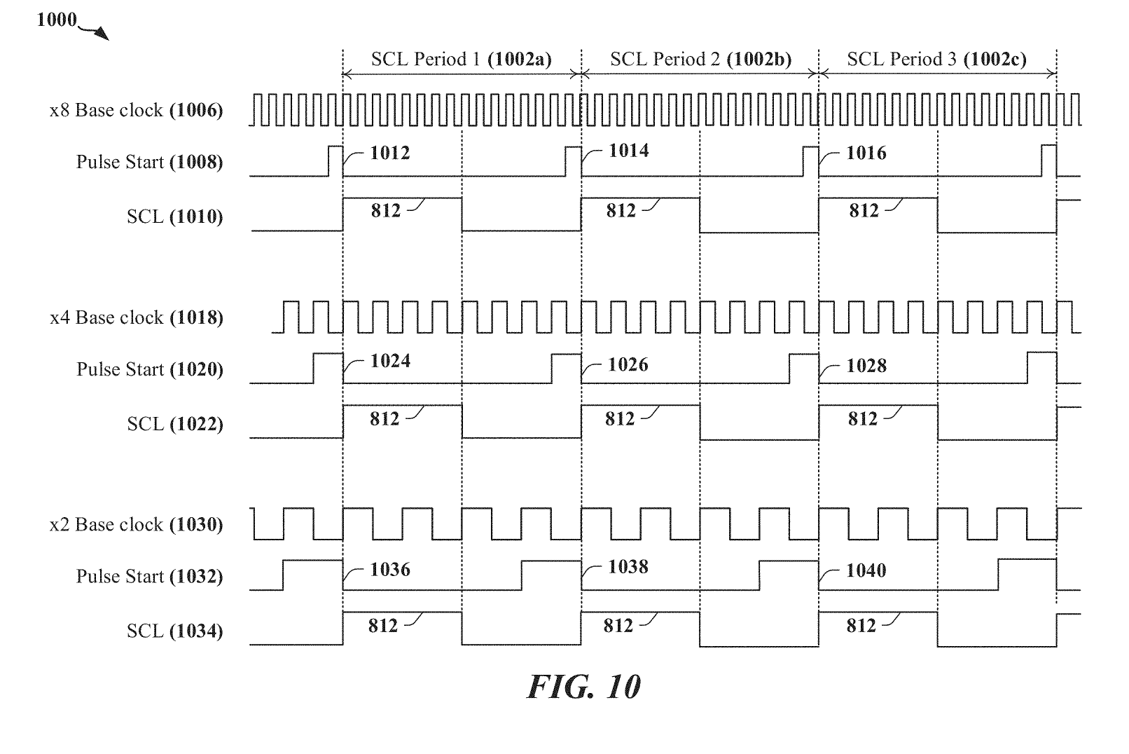

The diagram 1000 in FIG. 10 illustrates timing associated with the generation of SCL clock signals 1010, 1022, 1034 for different base clocks 1006, 1018, 1030. The SCL clock signals 1010, 1022, 1034 may be generated using any of the modes of operation illustrated in FIG. 9. Here, the clock generation circuit 1100 operates under the control of a pulse start signal 1008, 1020, 1032 to generate pulses 812 in the SCL clock signals 1010, 1022, 1034. The duration of the pulses 812 in the SCL clock signals 1010, 1022, 1034 are generated to meet protocol requirements. Each pulse 812 is launched at the beginning of a corresponding SCL period 1002a, 1002b, 1002c, after a control pulse 1012, 1014, 1016, 1024, 1026, 1028, 1036, 1038, 1040 has been generated on the pulse start signal 1008, 1020, 1032. In the illustrated example, the control pulses 1012, 1014, 1016, 1024, 1026, 1028, 1036, 1038, 1040 have a duration of one cycle of the base clock 1006, 1018, 1030 and pulses 812 are initiated in the SCL clock signals 1010, 1022, 1034 on the falling edge of the control pulses 1012, 1014, 1016, 1024, 1026, 1028, 1036, 1038, 1040. The duration of the SCL period 1002a, 1002b, 1002c is controlled by the timing of the control pulses 1012, 1014, 1016, 1024, 1026, 1028, 1036, 1038, 1040 and may vary without affecting the duration of the pulses 812 in the SCL clock signals 1010, 1022, 1034.

In one example, each pulse 812 in the SCL clock signal 1010 has a duration that is eight times the period of the base clock 1006. In another example, each pulse 812 in the SCL clock signal 1022 has a duration that is four times the period of the base clock 1018. In another example, each pulse 812 in the SCL clock signal 1034 has a duration that is twice the period of the base clock 1030. In each example, the duration of the pulses 812 in each pulse start signal 1008, 1020, 1032 can be configured to meet specified limits defined by protocol, while the duration of the low states between pulses 812 may be configured as needed or desired.

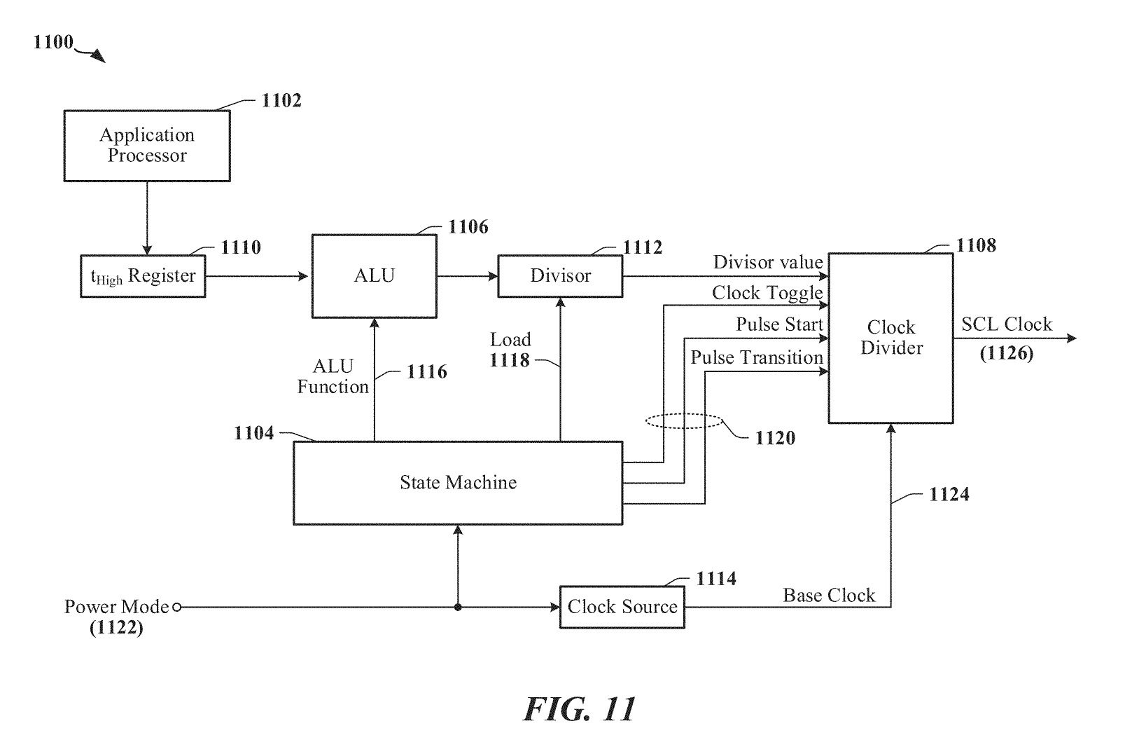

According to certain aspects, the clock generation circuit 1100 of FIG. 11 provides a variable clock divider that can accommodate various base clock frequencies, including the frequencies of the base clocks 1006, 1018, 1030 illustrated in FIG. 10 and other base clock frequencies that are not obtainable using power of 2 division. For example, the duration of the pulse 812 may be reliably obtained when the period of the base clock is 3x, 5x, etc. the desired duration of the pulse 812.

The illustrated clock generation circuit 1100 includes a clock divider 1108 that may be controlled by a state machine 1104 or another type of controller/processor. An application processor 1102 may determine an operating configuration for the clock generation circuit 1100. For example, the application processor 1102 may configure a register 1110 with a value representing the t_{high} duration. The content of the register 1110 may be used to select or calculate a divisor maintained in a divisor register 1112 used to generate pulses in an SCL clock signal 1126.

A power mode signal 1122 may indicate the frequency of the base clock signal 1124. In one example, the power mode signal 1122 may be provided by a power mode circuit (PMC). In some instances, the power mode signal 1122 may be provided by the application processor 1102, the state machine 1104, or another processor. The power mode signal 1122 may be provided to a clock generation circuit 1114 that sources the base clock signal 1124. The state machine 1104 may configure an arithmetic logic unit (ALU 1106) through a command 1116 or other communication, and based on the power mode signal 1122 and/or the frequency of the base clock signal 1124 reported by the clock generation circuit 1114, a PMC, or another source. In some implementations, the frequency of the base clock signal 1124 may be determined by measurement and/or through the use of a table of frequencies accessible to the state machine 1104. The ALU 1106 may calculate a divisor using the value representing the t_{high} duration and the command 1116. The divisor may be loaded into the divisor register 1112 in response to a load signal 1118 provided by the state machine 1104. The divisor register 1112 provides the divisor to the clock divider 1108.

The clock divider 1108 may be configured to respond to one or more controls 1120. The controls 1120 may include the clock toggle signal 910, the pulse start signal 914 and/or the pulse transition signal 918 described in relation to FIG. 9. The clock divider 1108 may monitor the controls 1120 to determine when pulses 812 should be generated. In one example, the clock divider 1108 may produce a stream of pulses 812 in the SCL clock signal 1126 after the clock toggle signal 910 transitions 922 to the high state, and may cease generating pulses 812 after the clock toggle signal 910 returns to the low state. In other examples, the clock divider 1108 may produce a pulse 812 in the SCL clock signal 1126 after each control pulse 924, 926, 928 930, 932, 934, 936, 938, 940 transmitted on the pulse start signal 914 or the pulse transition signal 918.

The clock divider 1108 may generate each pulse 812 by dividing the base clock signal 1124 in accordance with the value of the divisor. The clock divider 1108 may drive the SCL clock signal 1126 high after determining that a pulse 812 is to be generated. Pulses may be generated in response to the pulse start signal 914, the pulse transition signal 918 and/or in response to internal timing, such as expiration of a timer. The SCL clock signal 1126 may be driven high for a number (N) of cycles of the base clock signal 1124, where N is determined using the divisor and a base number configured by the state machine 1104 or application processor 1102. In one example, the base number may correspond to the number of clock cycles in a pulse 812 when the base clock signal 1124 has a maximum frequency.

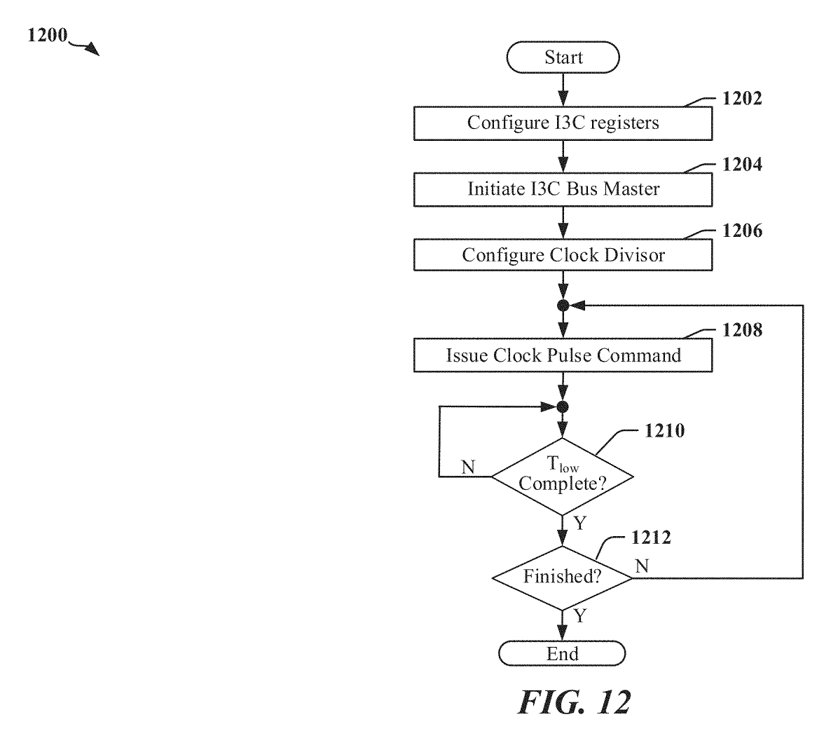

FIG. 12 is a flowchart 1200 that illustrates an example of a configuration process used to configure a master device for I3C HDR mode communication over a serial bus in accordance with certain aspects disclosed herein. The process may be implemented at an application processor and/or a state machine in a bus master device.

At block 1202, the application processor may configure certain I3C registers. The I3C registers may define certain aspects of a transaction to be performed. The I3C registers may indicate a power management mode in force at the master device. The I3C registers may identify a base clock frequency, a pulse width for an SCL signal, which may be expressed in a number of cycles of the base clock frequency, and other characteristics of the signal to be transmitted over the serial bus.

At block 1204, the application processor may initiate the bus master. The bus master may perform certain bus management procedures during initiation, including determining a state of the serial bus, source and destination of information to be transmitted in the transaction, and other information.

At block 1206, the application processor may cooperate with the state machine to configure a divisor appropriated for the mode of communication and power management state.

At block 1208, the state machine may issue a clock pulse command to a clock divider. The clock pulse command may be issued as a pulse on a control signal. The pulse may have a duration of one cycle of the base clock. In response to the clock pulse command, the clock divider may generate a pulse in the SCL signal using the divisor and base clock to determine the desired duration of the pulse in the SCL signal. The SCL signal may be high while the pulse is transmitted. When the pulse is complete, the SCL signal returns to a low state. The low state is maintained for a period of time that may be configured to obtain a desired cycle time of the SCL signal, and/or to stretch the SCL signal when indicated by the bus master or application processor.

At block 1210, the state machine may determine if the minimum low state has been completed. The state machine may cycle at block 1210 until the minimum low state has been completed. When the minimum low state has been completed, the state machine continues at block 1212.

At block 1212, the state machine may determine if any further data bits are to be transmitted in the transaction. If more data bits are to be exchanged, the state machine may initiate another clock pulse by continuing at block 1208. If no more data bits are to be exchanged, the process may be terminated.

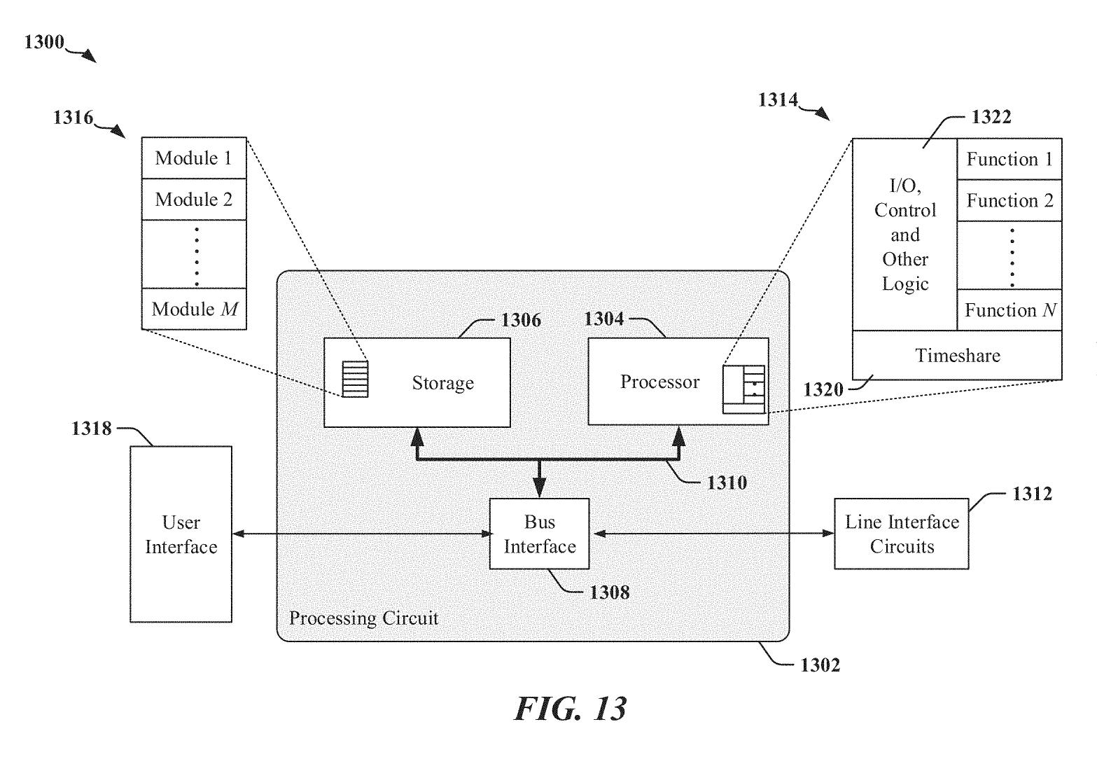

FIG. 13 is a conceptual diagram illustrating a simplified example of a hardware implementation for an apparatus 1300 employing a processing circuit 1302 that may be configured to perform one or more functions disclosed herein. In accordance with various aspects of the disclosure, an element, or any portion of an element, or any combination of elements as disclosed herein may be implemented using the processing circuit 1302. The processing circuit 1302 may include one or more processors 1304 that are controlled by some combination of hardware and software modules. Examples of processors 1304 include microprocessors, microcontrollers, digital signal processors (DSPs), field programmable gate arrays (FPGAs), programmable logic devices (PLDs), state machines, sequencers, gated logic, discrete hardware circuits, and other suitable hardware configured to perform the various functionality described throughout this disclosure. The one or more processors 1304 may include specialized processors that perform specific functions, and that may be configured, augmented or controlled by one of the software modules 1316. The one or more processors 1304 may be configured through a combination of software modules 1316 loaded during initialization, and further configured by loading or unloading one or more software modules 1316 during operation.

In the illustrated example, the processing circuit 1302 may be implemented with a bus architecture, represented generally by the bus 1310. The bus 1310 may include any number of interconnecting buses and bridges depending on the specific application of the processing circuit 1302 and the overall design constraints. The bus 1310 links together various circuits including the one or more processors 1304, and storage 1306. Storage 1306 may include memory devices and mass storage devices, and may be referred to herein as computer-readable media and/or processor-readable media. The bus 1310 may also link various other circuits such as timing sources, timers, ALUs, peripherals, voltage regulators, and power management circuits. A bus interface 1308 may provide an interface between the bus 1310 and one or more transceivers 1312. A transceiver 1312 may be provided for each networking technology supported by the processing circuit. In some instances, multiple networking technologies may share some or all of the circuitry or processing modules found in a transceiver 1312. Each transceiver 1312 provides a means for communicating with various other apparatus over a transmission medium. Depending upon the nature of the apparatus, a user interface 1318 (e.g., keypad, display, speaker, microphone, joystick) may also be provided, and may be communicatively coupled to the bus 1310 directly or through the bus interface 1308.

A processor 1304 may be responsible for managing the bus 1310 and for general processing that may include the execution of software stored in a computer-readable medium that may include the storage 1306. In this respect, the processing circuit 1302, including the processor 1304, may be used to implement any of the methods, functions and techniques disclosed herein. The storage 1306 may be used for storing data that is manipulated by the processor 1304 when executing software, and the software may be configured to implement any one of the methods disclosed herein.

One or more processors 1304 in the processing circuit 1302 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1306 or in an external computer-readable medium. The external computer-readable medium and/or storage 1306 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium and/or storage 1306 may also include, by way of example, a carrier wave, a transmission line, and any other suitable medium for transmitting software and/or instructions that may be accessed and read by a computer. Computer-readable medium and/or the storage 1306 may reside in the processing circuit 1302, in the processor 1304, external to the processing circuit 1302, or be distributed across multiple entities including the processing circuit 1302. The computer-readable medium and/or storage 1306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1306 may maintain software maintained and/or organized in loadable code segments, modules, applications, programs, etc., which may be referred to herein as software modules 1316. Each of the software modules 1316 may include instructions and data that, when installed or loaded on the processing circuit 1302 and executed by the one or more processors 1304, contribute to a run-time image 1314 that controls the operation of the one or more processors 1304. When executed, certain instructions may cause the processing circuit 1302 to perform functions in accordance with certain methods, algorithms and processes described herein.

Some of the software modules 1316 may be loaded during initialization of the processing circuit 1302, and these software modules 1316 may configure the processing circuit 1302 to enable performance of the various functions disclosed herein. For example, some software modules 1316 may configure internal devices and/or logic circuits 1322 of the processor 1304, and may manage access to external devices such as the transceiver 1312, the bus interface 1308, the user interface 1318, timers, mathematical coprocessors, and so on. The software modules 1316 may include a control program and/or an operating system that interacts with interrupt handlers and device drivers, and that controls access to various resources provided by the processing circuit 1302. The resources may include memory, processing time, access to the transceiver 1312, the user interface 1318, and so on.

One or more processors 1304 of the processing circuit 1302 may be multifunctional, whereby some of the software modules 1316 are loaded and configured to perform different functions or different instances of the same function. The one or more processors 1304 may additionally be adapted to manage background tasks initiated in response to inputs from the user interface 1318, the transceiver 1312, and device drivers, for example. To support the performance of multiple functions, the one or more processors 1304 may be configured to provide a multitasking environment, whereby each of a plurality of functions is implemented as a set of tasks serviced by the one or more processors 1304 as needed or desired. In one example, the multitasking environment may be implemented using a timesharing program 1320 that passes control of a processor 1304 between different tasks, whereby each task returns control of the one or more processors 1304 to the timesharing program 1320 upon completion of any outstanding operations and/or in response to an input such as an interrupt. When a task has control of the one or more processors 1304, the processing circuit is effectively specialized for the purposes addressed by the function associated with the controlling task. The timesharing program 1320 may include an operating system, a main loop that transfers control on a round-robin basis, a function that allocates control of the one or more processors 1304 in accordance with a prioritization of the functions, and/or an interrupt driven main loop that responds to external events by providing control of the one or more processors 1304 to a handling function.

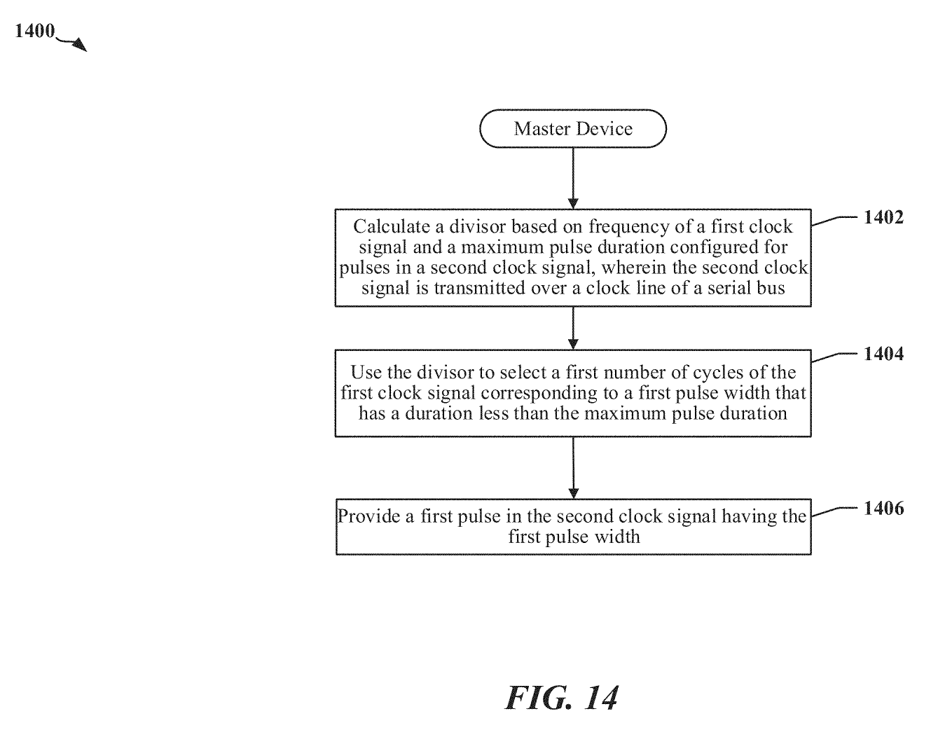

FIG. 14 includes a flowchart 1400 illustrating a method for generating clock pulses in a clock signal to be transmitted on a serial bus 302. Various steps of the method may be performed by a master device 304 coupled to the serial bus 302.

At block 1402, the master device 304 may calculate a divisor based on frequency of a first clock signal and a maximum pulse duration configured for clock pulses in a second clock signal. The second clock signal may be transmitted over a clock line of a serial bus. At block 1404, the master device 304 may use the divisor to select a first number of cycles of the first clock signal corresponding to a first pulse width that has a duration less than the maximum pulse duration. At block 1406, the master device 304 may provide a first clock pulse in the second clock signal having the first pulse width.

In certain implementations, the master device 304 may use the divisor to select a second number of cycles of the first clock signal that selects a clock period for the second clock signal, and may provide a second clock pulse in the second clock signal after the first clock pulse is terminated and after a delay defined by the second number of cycles of the first clock signal. In one example, the master device 304 may provide a third clock pulse in the second clock signal after the second clock pulse is terminated and after a delay defined by the second number of cycles of the first clock signal and one or more additional cycles of the first clock signal. In certain examples, the master device 304 may provide a first control pulse in one or more control signals, where the first clock pulse is initiated in the second clock signal responsive to the first control pulse. The master device 304 may provide a second control pulse in the one or more control signals after the first control pulse, where the second clock pulse is initiated in the second clock signal responsive to the second control pulse. The master device 304 may provide a terminating control pulse in the one or more control signals after the first control pulse, where the first clock pulse is terminated responsive to the terminating control pulse.

In some implementations, master device 304 may determine that the first clock signal has a changed frequency, recalculate the divisor based on the changed frequency and the maximum pulse duration configured for clock pulses in the second clock signal. The master device 304 may use the recalculated divisor to select an updated number of cycles of the first clock signal corresponding to a second pulse width that has a duration less than the maximum pulse duration, and may provide at least one clock pulse in the second clock signal having the second pulse width. The frequency of the first clock signal may change in response to a power-management command.

In certain implementations, the maximum pulse duration is selected to cause a spike filter of an I2C slave device to suppress the first clock pulse. For example, the duration of the maximum pulse duration is less than 50 nanoseconds. The second clock signal may be generated when the serial bus is operated in an I3C HDR mode of operation.

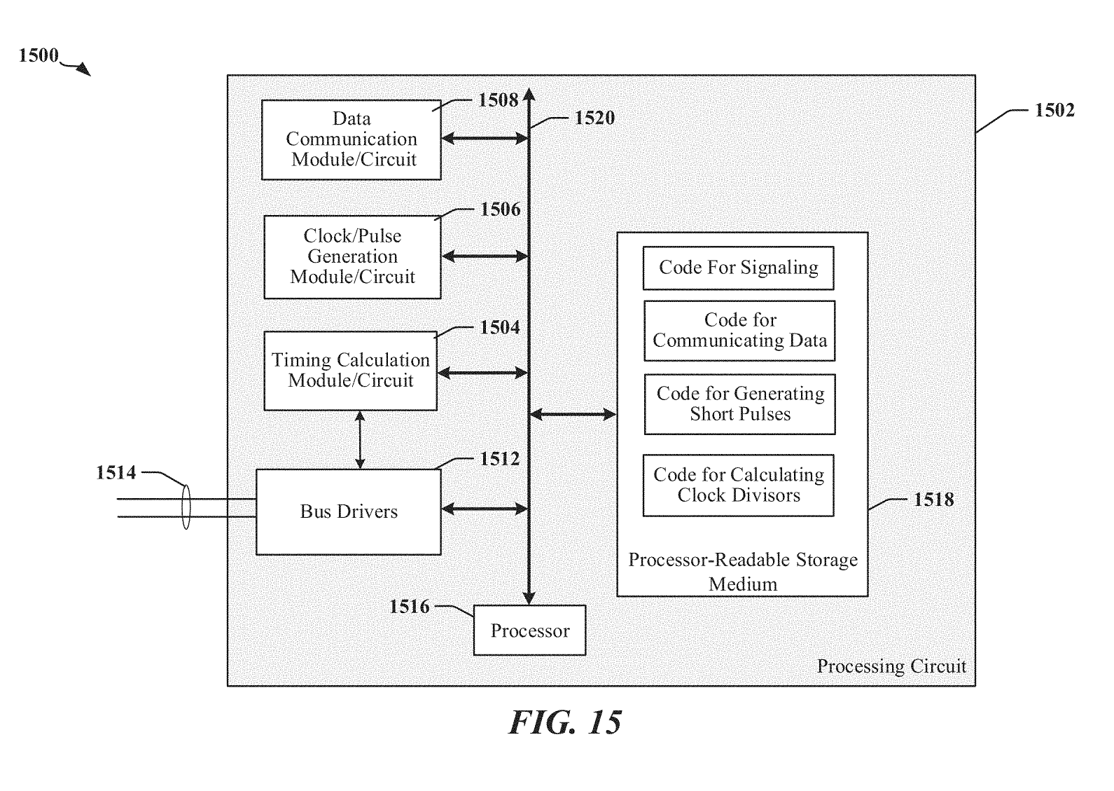

FIG. 15 is a diagram illustrating a simplified example of a hardware implementation for an apparatus 1500 employing a processing circuit 1502. The processing circuit typically has a processor 1516 that may include one or more of a microprocessor, microcontroller, digital signal processor, a sequencer and a state machine. The processing circuit 1502 may be implemented with a bus architecture, represented generally by the bus 1520. The bus 1520 may include any number of interconnecting buses and bridges depending on the specific application of the processing circuit 1502 and the overall design constraints. The bus 1520 links together various circuits including one or more processors and/or hardware modules, represented by the processor 1516, the modules or circuits 1504, 1506 and 1508, line interface circuits 1512 configurable to communicate over a serial bus 1514 that includes a plurality of connectors or wires, and the processor-readable storage medium 1518. The bus 1520 may also link various other circuits such as timing sources, peripherals, voltage regulators, and power management circuits, which are well known in the art, and therefore, will not be described any further.

The processor 1516 is responsible for general processing, including the execution of software stored on the processor-readable storage medium 1518. The software, when executed by the processor 1516, causes the processing circuit 1502 to perform the various functions described supra for any particular apparatus. The processor-readable storage medium 1518 may also be used for storing data that is manipulated by the processor 1516 when executing software, including data decoded from symbols transmitted over the serial bus 1514. The processing circuit 1502 further includes at least one of the modules 1504, 1506 and 1508. The modules 1504, 1506 and 1508 may be software modules running in the processor 1516, resident/stored in the processor-readable storage medium 1518, one or more hardware modules coupled to the processor 1516, or some combination thereof. The modules 1504, 1506 and 1508 may include microcontroller instructions, state machine configuration parameters, or some combination thereof.

In one configuration, the apparatus 1500 includes a circuit that is configured to generate clock pulses for a clock signal to be transmitted on the serial bus 1514, a module and/or circuit 1504 that is configured to calculate timing, divisors and other parameters used while generating the clock pulses, and a module and/or circuit 1508 that is configured to transmit the clock signal on the serial bus 1514.

In certain examples, the apparatus 1500 has an interface circuit adapted to couple the apparatus 1500 to the serial bus 1514, a processing system and a clock divider circuit. The processing system may be configured to calculate a divisor based on frequency of a first clock signal and a maximum pulse duration configured for clock pulses in a second clock signal. The second clock signal may be transmitted over a clock line of the serial bus 1514. The clock divider circuit may be configured to use the divisor to select a first number of cycles of the first clock signal corresponding to a first pulse width that has a duration less than the maximum pulse duration, and provide a first clock pulse in the second clock signal having the first pulse width

In one example, the clock divider circuit is further configured to use the divisor to select a second number of cycles of the first clock signal that selects a clock period for the second clock signal, and provide a second clock pulse in the second clock signal after the first clock pulse is terminated and after a delay defined by the second number of cycles of the first clock signal. The clock divider circuit may be further configured to provide a third clock pulse in the second clock signal after the second clock pulse is terminated and after a delay defined by the second number of cycles of the first clock signal and one or more additional cycles of the first clock signal.

In one example, the processing system is further configured to provide a first control pulse in one or more control signals, and the clock divider circuit is further configured to initiate the first clock pulse in the second clock signal in response to the first control pulse. The processing system may be further configured to provide a second control pulse in the one or more control signals after the first control pulse, and the clock divider circuit may be further configured to initiate the second clock pulse in the second clock signal in response to the second control pulse. The processing system may be further configured to provide a terminating control pulse in the one or more control signals after the first control pulse, and the clock divider circuit may be further configured to terminate the first clock pulse in response to the terminating control pulse.

In one example, the processing system is further configured to determine when the first clock signal has a changed frequency, and recalculate the divisor based on the changed frequency and the maximum pulse duration configured for clock pulses in the second clock signal. The clock divider circuit may be further configured to use the recalculated divisor to select an updated number of cycles of the first clock signal corresponding to a second pulse width that has a duration less than the maximum pulse duration, and provide at least one clock pulse in the second clock signal having the second pulse width. The frequency of the first clock signal may change in response to a power-management command.

The processor-readable storage medium 1518 may include code for calculating a divisor based on frequency of a first clock signal and a maximum pulse duration configured for clock pulses in a second clock signal, where the second clock signal is transmitted over a clock line of a serial bus, using the divisor to select a first number of cycles of the first clock signal corresponding to a first pulse width that has a duration less than the maximum pulse duration, and providing a first clock pulse in the second clock signal having the first pulse width.

The processor-readable storage medium 1518 may also include code for using the divisor to select a second number of cycles of the first clock signal that selects a clock period for the second clock signal, and providing a second clock pulse in the second clock signal after the first clock pulse is terminated and after a delay defined by the second number of cycles of the first clock signal. The processor-readable storage medium 1518 may also include code for providing a third clock pulse in the second clock signal after the second clock pulse is terminated and after a delay defined by the second number of cycles of the first clock signal and one or more additional cycles of the first clock signal. The processor-readable storage medium 1518 may also include code for providing a first control pulse in one or more control signals. The first pulse may be initiated in the second clock signal responsive to the first control pulse. The processor-readable storage medium 1518 may also include code for providing a second control pulse in the one or more control signals after the first control pulse. The second pulse may be initiated in the second clock signal responsive to the second control pulse.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for generating clock pulses, comprising:
calculating a divisor based on frequency of a first clock signal and a maximum pulse duration configured for clock pulses in a second clock signal, wherein the second clock signal is transmitted over a clock line of a serial bus;
using the divisor to select a first number of cycles of the first clock signal corresponding to a first pulse width that has a duration less than the maximum pulse duration; and
providing a first clock pulse in the second clock signal having the first pulse width.

2. The method of claim 1, further comprising:
using the divisor to select a second number of cycles of the first clock signal that selects a clock period for the second clock signal; and
providing a second clock pulse in the second clock signal after the first clock pulse is terminated and after a delay defined by the second number of cycles of the first clock signal.

3. The method of claim 2, further comprising:
providing a third clock pulse in the second clock signal after the second clock pulse is terminated and after a delay defined by the second number of cycles of the first clock signal and one or more additional cycles of the first clock signal.

4. The method of claim 1, further comprising:
providing a first control pulse in one or more control signals, wherein the first clock pulse is initiated in the second clock signal responsive to the first control pulse.

5. The method of claim 4, further comprising:
providing a second control pulse in the one or more control signals after the first control pulse, wherein the second clock pulse is initiated in the second clock signal responsive to the second control pulse.

6. The method of claim 4, further comprising:
providing a terminating control pulse in the one or more control signals after the first control pulse, wherein the first clock pulse is terminated responsive to the terminating control pulse.

7. The method of claim 1, further comprising:
determining that the first clock signal has a changed frequency;
recalculating the divisor based on the changed frequency and the maximum pulse duration configured for clock pulses in the second clock signal;
using the recalculated divisor to select an updated number of cycles of the first clock signal corresponding to a second pulse width that has a duration less than the maximum pulse duration; and
providing at least one clock pulse in the second clock signal having the second pulse width.

8. The method of claim 7, wherein the frequency of the first clock signal changes in response to a power-management command.

9. The method of claim 1, wherein the maximum pulse duration is selected to cause a spike filter of an I2C slave device to suppress the first clock pulse.

10. The method of claim 1, wherein the maximum pulse duration is less than 50 nanoseconds.

11. The method of claim 1, wherein the second clock signal is generated when the serial bus is operated in an I3C high data rate mode of operation.

12. A data communication apparatus comprising:
an interface circuit adapted to couple the data communication apparatus to a serial bus;
a processing system configured to:
calculate a divisor based on frequency of a first clock signal and a maximum pulse duration configured for clock pulses in a second clock signal, wherein the second clock signal is transmitted over a clock line of the serial bus; and
a clock divider circuit configured to:
use the divisor to select a first number of cycles of the first clock signal corresponding to a first pulse width that has a duration less than the maximum pulse duration; and
provide a first clock pulse in the second clock signal having the first pulse width.

13. The data communication apparatus of claim 12, wherein the clock divider circuit is further configured to:
use the divisor to select a second number of cycles of the first clock signal that selects a clock period for the second clock signal; and
provide a second clock pulse in the second clock signal after the first clock pulse is terminated and after a delay defined by the second number of cycles of the first clock signal.

14. The data communication apparatus of claim 13, wherein the clock divider circuit is further configured to:
provide a third clock pulse in the second clock signal after the second clock pulse is terminated and after a delay defined by the second number of cycles of the first clock signal and one or more additional cycles of the first clock signal.

15. The data communication apparatus of claim 12, wherein:
the processing system is further configured to provide a first control pulse in one or more control signals; and
the clock divider circuit is further configured to initiate the first clock pulse in the second clock signal in response to the first control pulse.

16. The data communication apparatus of claim 15, wherein:
the processing system is further configured to provide a second control pulse in the one or more control signals after the first control pulse; and
the clock divider circuit is further configured to initiate the second clock pulse in the second clock signal in response to the second control pulse.

17. The data communication apparatus of claim 15, wherein:
the processing system is further configured to provide a terminating control pulse in the one or more control signals after the first control pulse; and
the clock divider circuit is further configured to terminate the first clock pulse in response to the terminating control pulse.

18. The data communication apparatus of claim 12, wherein:
the processing system is further configured to:
determine that the first clock signal has a changed frequency; and
recalculate the divisor based on the changed frequency and the maximum pulse duration configured for clock pulses in the second clock signal; and
the clock divider circuit is further configured to:
use the recalculated divisor to select an updated number of cycles of the first clock signal corresponding to a second pulse width that has a duration less than the maximum pulse duration; and
provide at least one clock pulse in the second clock signal having the second pulse width.

19. The data communication apparatus of claim 18, wherein the frequency of the first clock signal changes in response to a power-management command.

20. The data communication apparatus of claim 12, wherein the maximum pulse duration is selected to cause a spike filter of an I2C slave device to suppress the first clock pulse.

21. The data communication apparatus of claim 12, wherein the maximum pulse duration is less than 50 nanoseconds.

22. The data communication apparatus of claim 12, wherein the second clock signal is generated when the serial bus is operated in an I3C high data rate mode of operation.

23. A processor-readable storage medium comprising code for:
calculating a divisor based on frequency of a first clock signal and a maximum pulse duration configured for clock pulses in a second clock signal, wherein the second clock signal is transmitted over a clock line of a serial bus;
using the divisor to select a first number of cycles of the first clock signal corresponding to a first pulse width that has a duration less than the maximum pulse duration; and
providing a first clock pulse in the second clock signal having the first pulse width.

24. The storage medium of claim 23, further comprising code for:
using the divisor to select a second number of cycles of the first clock signal that selects a clock period for the second clock signal; and
providing a second clock pulse in the second clock signal after the first clock pulse is terminated and after a delay defined by the second number of cycles of the first clock signal.

25. The storage medium of claim 24, further comprising code for:
providing a third clock pulse in the second clock signal after the second clock pulse is terminated and after a delay defined by the second number of cycles of the first clock signal and one or more additional cycles of the first clock signal.

26. The storage medium of claim 23, further comprising code for:
providing a first control pulse in one or more control signals, wherein the first clock pulse is initiated in the second clock signal responsive to the first control pulse.

27. The storage medium of claim 26, further comprising code for:
providing a second control pulse in the one or more control signals after the first control pulse, wherein the second clock pulse is initiated in the second clock signal responsive to the second control pulse.

28. The storage medium of claim 26, further comprising code for:
providing a terminating control pulse in the one or more control signals after the first control pulse, wherein the first clock pulse is terminated responsive to the terminating control pulse.

29. A data communication apparatus comprising:
means for calculating a divisor based on frequency of a first clock signal and a maximum pulse duration configured for clock pulses in a second clock signal, wherein the second clock signal is transmitted over a clock line of a serial bus;
means for generating clock pulses, configured to use the divisor to select a first number of cycles of the first clock signal corresponding to pulse width of the clock pulses, the pulse width having a duration less than the maximum pulse duration; and
means for transmitting the clock pulses in the second clock signal.
